(19) United States
(12) Patent Application Publication
(10) Pub. No.: US 2011/0234981 A1
(43) Pub. Date: Sep. 29, 2011

(54) LARGE THREE-DIMENSIONAL IMAGE FORMATION DEVICE

(75) Inventor: Tsung-Wu Wang, Taipei City (TW)

(73) Assignee: TENDRIL-TECH CO., LTD., Taipei City (TW)

(21) Appl. No.: 12/731,343

(22) Filed: Mar. 25, 2010

(51) Int. Cl. G02B 27/22; G03B 21/28

(52) U.S. Cl. 353/10

(57) ABSTRACT

A large three-dimensional 3D image formation device includes four projectors, four optical reflecting lenses, four transparent reflecting lenses, mounting box and four image source reflecting lenses. The projectors project images onto the optical reflecting lenses, and the images are reflected to the image source optical reflecting lenses, such that the image source optical reflecting lenses have image source patterns, and the four image source patterns are projected to the four transparent reflecting lenses combined into an inverted pyramid shape, such that the four image source patterns can be combined at the center of the four transparent reflecting lenses, and viewers can see a 3D image floating in the air from any angle. The large three-dimensional 3D image formation device provides a lively 3D perception to enhance the value of the product.

### BACKGROUND OF THE INVENTION

1. Field of the Invention

The present invention relates to a large three-dimensional 3D image formation device comprised of four projectors, four optical reflecting lenses, four transparent reflecting lenses, a mounting box and four image source reflecting lenses, and uses the projectors to project images onto the optical reflecting lenses, and then reflects the images onto the image source reflecting lenses, such that the image source reflecting lenses having image source patterns, and the four image source patterns are projected onto the four transparent reflecting lenses arranged in an inverted pyramid shape, and the four image source patterns are combined at the center of the four transparent reflecting lenses. As a result, a viewer can see a 3D image floating in the air from any angle of the 360 degrees, and the invention can give a lively 3D perception of the image to enhance the value of the product.

2. Description of the Related Art

In binocular vision, an object is observed from two viewing angles or left and right eyes simultaneously. Positions of left and right eyes are different, so that there is a slight difference between the images observed by the left and right eyes, and such difference becomes a main cause of producing 3D images.

The so-called “persistence of vision” refers to the phenomenon where our eyes retain an image temporarily after the image was actually seen and removed. For example, the persistence of vision is used for the production of cartoon movies. Pictures of a continuous motion are drawn on a stack of paper one by one according to the motion of a character. Before an image disappears completely, another image shows up in front of our eyes, due to the persistence of vision. Now, the eyes will produce an illusion with the effect like “a piece of still paper is moving”. If more pieces of pictures of the continuous motion are flipped in a specific time, then the motion of the character will become smoother and more realistic.

The frames of televisions and movies are also made by the same principles, except that approximately 15˜20 frames are played per second in general cartoon movies, and 24˜30 frames are played per second in televisions and movies.

Although the principles of forming 3D images have been developed for a long time, the 3D effect is still not good, and the bottleneck of forming a high-quality 3D image cannot be broken through. Furthermore, the prior art makes use of different spectral wavelengths and a time difference of one-thirtieth frame per second to cover the left and right eyes in order to produce an illusion of the 3D image. Users need to wear a pair of 3D glasses to see the 3D effect. Obviously, the prior art is inconvenient. In view of the shortcomings of the conventional products, the inventor of the present invention based on years of experience in the related industry to conduct extensive researches and experiments, and finally developed a large 3D image formation device in accordance with the present invention.

### SUMMARY OF THE INVENTION

It is a primary objective of the present invention to overcome the shortcomings of the prior art by providing a large 3D image formation device comprising four projectors, four optical reflecting lenses, four transparent reflecting lenses, mounting box and four image source reflecting lenses, wherein the projectors project images onto the optical reflecting lenses, and then the optical reflecting lenses reflect the images to the image source optical reflecting lenses, such that the image source optical reflecting lenses have image source patterns, and the four image source patterns are projected to four transparent reflecting lenses combined into an inverted pyramid shape, and the four image source patterns are combined at the center of the four transparent reflecting lenses. As a result, a viewer can see a 3D image floating in the air from any angle to achieve a lively 3D perception to enhance the value of the product.

To achieve the foregoing objective, the present invention adopts the following technical measures.

With reference to FIGS. 1 to 3 for a large 3D image formation device of the present invention, the large 3D image formation device comprises projectors 10, optical reflecting lenses 2, transparent reflecting lenses 3, a mounting box 4 and image source reflecting lenses 5.

The four projectors 10 are installed at top edges in four directions of east, west, south and north respectively for providing image playing sources, and a power cord 11 is connected at the bottom of the projectors 10 for supplying electric power.

The four optical reflecting lenses 2 are installed and tilted at an appropriate angle by a plurality of fixing rods 21 and the projectors 10 respectively, and the fixing rods 21 can adjust the distance between the optical reflecting lenses 2 and the projectors 10.

Each of the four transparent reflecting lenses 3 includes a see-through reflecting film 31 attached on an external surface of the transparent reflecting lens 3, and the four transparent reflecting lenses 3 are combined into an inverted pyramid shape, fixed at the bottom of the four projectors 10, and supported by the mounting box 4, and the four transparent reflecting lenses 3 are installed at an angle of 45 degrees with respect to the ground 8.

The four image source reflecting lenses 5 are installed on the ground and corresponding to the four transparent reflecting lenses 3 respectively to form an integral structure for showing a large 3D image 6.

With reference to FIG. 4 for the principles of forming a large 3D image in accordance with the present invention, the transparent reflecting lenses 3 and the image source optical reflecting lenses 5 are installed and tilted at an angle of 45 degrees, wherein the distance D1 between the image source position 51 and the image reflecting position 32 is equal to the distance D2 between the image reflecting position 32 and the image forming position 62, so that the images can be combined into a 3D image at the image forming position 62.

To make it easier for our examiner to understand the objects, effects and advantages of the present invention, we use preferred embodiments with related drawings for the detailed description of the present invention as follows.

### BRIEF DESCRIPTION OF THE DRAWINGS

FIG. 1 is a perspective view of the present invention;

FIG. 2 is a schematic view of a 3D image formation device in accordance with the present invention;

FIG. 3 is a schematic view of a lateral side of a transparent reflecting lens in accordance with the present invention; and

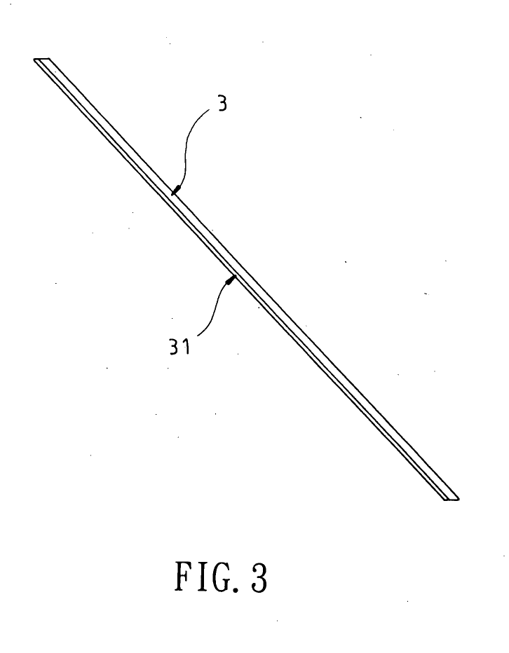

FIG. 4 is a schematic view of the principles of forming a large 3D image in accordance with the present invention.

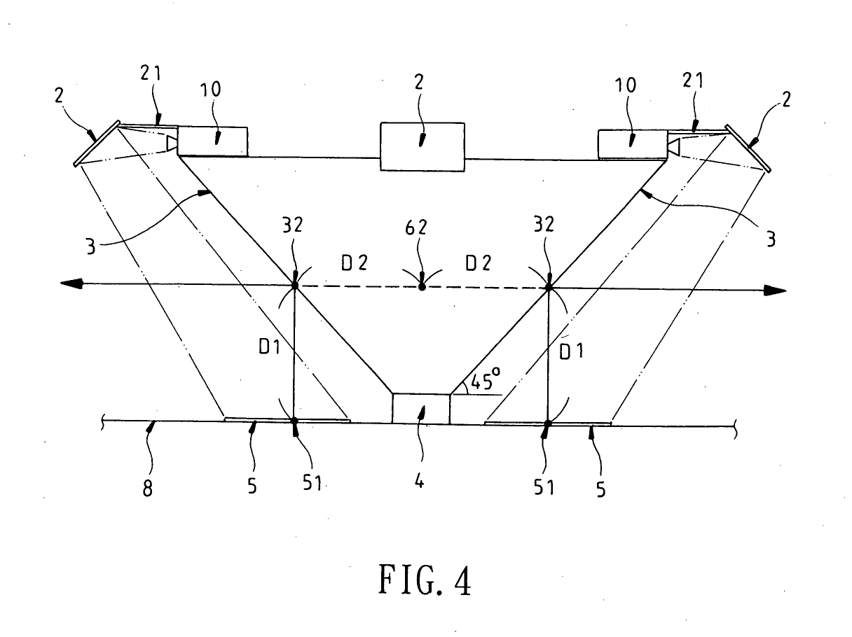

### DETAILED DESCRIPTION OF THE PREFERRED EMBODIMENTS

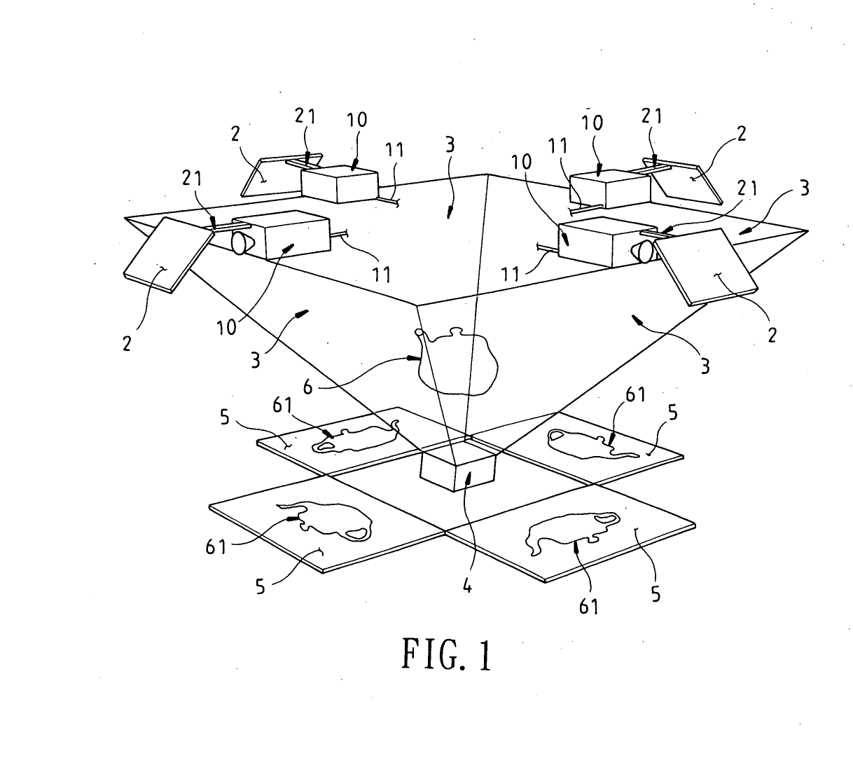

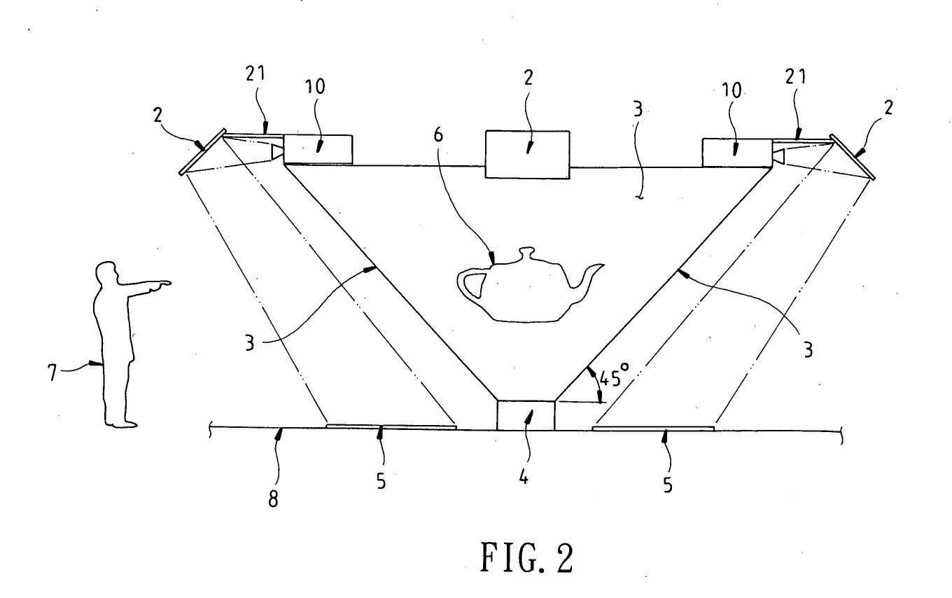

With reference to FIGS. 1 and 2 for the components before the large 3D image formation device of the invention are assembled, projectors 10 are provided for projecting images to optical reflecting lenses 2 installed and tilted at an appropriate angle, and then the images are reflected to image source optical reflecting lenses 5, so that the image source optical reflecting lenses 5 have image source patterns 61. The present invention uses the principles of reflection to project the images by the projectors 10 and further uses the reflection of lenses and lenses to increase the projection distance, and the projection distance and the size of the projected image are directly proportional to each other, so that the invention effectively utilizes the space to obtain large sharp images and avoids occupying too much space for receiving sufficiently large image sources.

The present invention uses four image source optical reflecting lenses 5 having four image source patterns 61 respectively, and the four image source patterns 61 are projected onto four transparent reflecting lenses 3 combined into an inverted pyramid shape, such that the four image source patterns 61 can be combined at the center of the inverted pyramid shape of the four transparent reflecting lenses 3, and viewers 7 can see a 3D image 6 floating in the air from any angle of the surrounding 360 degrees. With the specific angles of reflections, the invention allows viewers 7 to see one image at a time from the same angle. For dynamic, rotating or moving images, a more lively 3D perception can be achieved.

While the invention has been described by means of specific embodiments, numerous modifications and variations could be made thereto by those skilled in the art without departing from the scope and spirit of the invention set forth in the claims.

In summation of the above description, the present invention herein enhances the performance than the conventional structure and further complies with the patent application requirements and is duly filed for patent application.

What is claimed is:

1. A large three-dimensional 3D image formation device, comprising: four projectors, four optical reflecting lenses, four transparent reflecting lenses, a mounting box and four image source reflecting lenses, characterized in that:
the four projectors are installed at top edges in four directions of east, west, south and north respectively for providing image playing sources, and a power cord is connected at a rear end of the bottom of the projectors for supplying electric power;
the four optical reflecting lenses are installed with a tilted angle with respect to the four projectors by a plurality of fixing rods respectively;
each of the four transparent reflecting lenses has a see-through reflecting film attached on an external surface of each transparent reflecting lens, and the four transparent reflecting lenses are combined into an inverted pyramid shape, fixed at the bottom of the four projectors, and supported by the mounting box, and the four transparent reflecting lenses are installed at an angle of 45 degrees with respect to the ground; and
the four image source reflecting lenses are installed on the ground and corresponding to the four transparent reflecting lenses to constitute an integral structure.
